(19) United States
(12) Patent Application Publication
(10) Pub. No.: US 2026/0213252 A1
(43) Pub. Date: Jul. 23, 2026

(54) METHOD AND APPARATUS FOR MANUFACTURING A BATTERY

(71) Applicant: MB Automation GmbH & Co. KG, Roding (DE)

(72) Inventors: Ernst SEMMELMANN, Bernhardswald (DE); Ondrej VASKO, Schwandorf (DE); Jessica MAYER, Dieterskirchen (DE)

(21) Appl. No.: 19/140,655

(22) PCT Filed: Dec. 22, 2023
(86) PCT No.: PCT/EP2023/087728

§ 371 Date: Jun. 18, 2025

(30) Foreign Application Priority Data
Dec. 23, 2022 (DE) 10 2022 134 785.0

(51) Int. Cl. H01M 10/04; B65G 47/24; B65G 47/91; G06T 7/00; H01M 50/105

(52) U.S. Cl. CPC H01M 10/049; B65G 47/24; B65G 47/91; G06T 7/0004; H01M 50/105; G06T 2207/30108

(57) ABSTRACT

The invention relates to a method for manufacturing a battery with an electrode stack and a receiving pouch. The method involves moving a pouch blank insertion position, optically measuring features of both the pouch and the electrode stack relative to the reference system, and calculating an alignment correction. This correction ensures that for electrode stack aligns accurately with the pouch's depression during insertion. The invention also relates to an apparatus for manufacturing a battery which has an electrode stack and a pouch for receiving the electrode stack, which apparatus includes movable workpiece carriers for holding pouch blanks, a gripping device with a position-adjustable and rotatable carrier for transporting the electrode stack, optical systems for detecting component positions, and a control unit for computing necessary adjustments for proper alignment.

The invention relates to a method for manufacturing a battery having an electrode stack and a pouch for receiving the electrode stack. The invention further relates to an apparatus for manufacturing such a battery.

During the manufacturing of such a battery, an electrode stack, for example a welded package of anodes, cathodes and separator foils, is inserted into a pouch. The pouch can then be filled with the required battery chemicals and sealed. Alternative designs for such batteries include a solid electrolyte that is inserted into the pouch together with the battery stack.

The more precisely the electrode stack is inserted into the pouch, the more precisely the permitted dimensions of the battery can be maintained. A precise arrangement of the electrode stack also has a positive influence on the service life of the battery. In addition, the correct positioning of the battery stack is important so that, for example, no elements of the battery, such as an electrode and/or a separator film, are damaged when closing the pouch. This reduces waste during production and increases the quality of the battery.

Machine tools that can precisely position both the pouch or a pouch blank for forming the pouch and the electrode stack are expensive to purchase and to operate.

Against this background, the present invention has the object of developing a method and an apparatus for manufacturing a battery of the type mentioned at the outset in such a way that the costs thereof are reduced while maintaining or improving precision.

The object is achieved by a method according to claim 1 and an apparatus according to claim 5. Further advantageous embodiments are the subject-matter of the dependent claims.

To achieve the object, a method for manufacturing a battery which has an electrode stack and a pouch for receiving the electrode stack comprises the following steps: a) moving a workpiece carrier with a pouch blank arranged thereon into an insertion position; b) measuring a position of at least two structures of a depression in the pouch blank relative to a reference system; c) moving a carrier of a gripping device, with the electrode stack fixed to the carrier, from a receiving position into the insertion position; d) during step c), measuring a position of at least two structures of the electrode stack relative to the reference system; e) calculating an alignment correction for the electrode stack on the basis of the positions of the structures in such a way that, when the electrode stack is inserted into the depression, the structures of the electrode stack and of the depression each come to lie adjacent to one another; and f) during step c), rotating and/or displacing the carrier with the electrode stack according to the alignment correction.

This method has the advantage that the transport of the workpiece carrier can be carried out with an imprecisely operating transport device. Any positioning errors of the workpiece carrier are corrected during the movement of the carrier of the gripping device. For this reason, only a precisely operating machine tool is required. In addition, the “on the fly” correction results in a time advantage compared to other methods.

In some embodiments, the method comprises the steps of: h) before step a), picking up a pouch blank from a transfer position; i) placing the pouch blank on the workpiece carrier; and j) fixing the pouch blank on the workpiece carrier.

This ensures that the pouch blank is reliably held in its position, so that the calculated alignment correction is not invalidated by a change in the position of the pouch blank.

In some embodiments, the method comprises the steps of: k) prior to step c), moving a second material carrier, on which the electrode stack is fixed, into the receiving position; I) unlocking the fixing of the electrode stack to the second material carrier; and m) receiving of the electrode stack by the carrier.

This ensures safe transport of the electrode stack until it is received by the carrier.

In some embodiments, the method comprises the following steps: in step b), creating at least one image of one or more corners of the depression in the pouch blank using a first camera and/or a second camera of a first optical position detection device, and/or, in step d), creating at least one image of one or more corners of the electrode stack using a first camera and/or a second camera of a second optical position detection device at least one image of one or more corners of the electrode stack is created, wherein the measurement is carried out by image processing on the basis of the image recordings.

Such a measurement using cameras allows the position detection devices to be arranged away from the travel path of the electrode stack and/or of the pouch blank. Only a visual contact with the corners is necessary. The position detection devices therefore do not occupy the scarce space near the transport route, which simplifies their installation and maintenance.

The invention is further achieved by an apparatus for manufacturing a battery, which has an electrode stack and a pouch for receiving the electrode stack which can be manufactured from a pouch blank with at least one depression by folding along a fold line, comprising a plurality of movable workpiece carriers on each of which a pouch blank can be arranged, a gripping device with a carrier that can be positioned in two spatial directions and rotated about one of the spatial directions for transporting the electrode stack from a receiving position to an insertion position in one of the depressions, a first optical position detection device for detecting a position of the pouch blank arranged on one of the workpiece carriers relative to a reference system, a second optical position detection device for detecting a position of the electrode stack relative to the reference system and a control device for ascertaining an alignment correction for the carrier and/or the workpiece carrier, comprising an item of translation and/or rotation information for positioning the electrode stack in the depression.

This means that only one machine tool is required which allows precise positioning. For example, the gripping device and/or its carrier allow precise positioning. In this case, positioning of the pouch blank on the workpiece carrier can have greater tolerances. The resulting deviations can then be compensated for by the gripping device and/or the carrier by applying the alignment correction.

In some embodiments, the second optical position detection device is arranged and configured to detect the position during the transport of the electrode stack from the receiving position to the insertion position.

As a result, particularly rapid manufacturing is achieved, since the electrode stack does not have to be stopped to detect its position.

In some embodiments, the second optical position detection device is arranged on a side of the electrode stack facing the gripping device.

This makes the second optical position detection device easily accessible, simplifying installation and setup of the optical position detection device.

In some embodiments, the second optical position detection device is arranged and configured to detect the positions of at least two structures, in particular corners of the electrode stack.

Corners are particularly easy to identify and still allow precise detection of the alignment of the electrode stack.

In some embodiments, the first optical position detection device is arranged and configured to detect the positions of at least two corners of a depression in the pouch blank.

Corners are particularly easy to identify and still allow precise detection of the alignment of the depression in the pouch blank.

In some embodiments, the electrode stack is fixed in the receiving position on a stack holder for being picked up, wherein a release device is provided for releasing the fixing.

This ensures that the electrode stack is dependably provided at a predetermined position for pick-up. Only when the electrode stack is being picked up by the gripping device is the unlocking device activated to release the electrode stack.

In some embodiments, the workpiece carrier comprises a folding device for folding the pouch blank along the fold line such that the electrode stack is enclosed by the two depressions, wherein the folding device has an open state and a closed state.

Such a folding device simplifies the manufacturing of the pouch from the pouch blank.

In some embodiments, a sealing station is provided at which a pouch blank with an electrode stack in a workpiece carrier can be at least partially sealed in the closed state.

The workpiece carrier in the closed state ensures that the pouch blank is folded in a defined position for sealing. This further improves the precision of the arrangement of the electrode stack and pouch.

In some embodiments, the carrier of the gripping device has a suction plate with vacuum openings for fixing the electrode stack to the carrier, wherein the carrier and/or the suction plate are designed such that at least corner regions of the electrode stack are visible from the side of the gripping device.

In addition to a reliable temporary attachment of the electrode stack to the carrier, this ensures that the optical position detection devices can continue to detect the position of the corners of the electrode stack.

In some embodiments, the device has a common insertion position for inserting the pouch blank into the workpiece carrier and inserting the electrode stack into the depression in the pouch blank.

This avoids having to transport the pouch blank on the workpiece carrier into the insertion position for the electrode stack. To do this, the pouch blank would have to be removed from the workpiece carrier, for example by means of a vacuum. However, supplying the movable workpiece carrier with vacuum would be quite complex, so the common insertion position simplifies the structure and maintenance of the device.

In some embodiments, the device comprises a transport path having a plurality of transport segments, wherein the transport segments are arranged and configured to transport the workpiece carriers between a plurality of positions, wherein the transport path is arranged and configured to form a circuit for the workpiece carriers, and wherein at least one insertion position is arranged on or at one of the transport segments.

By forming the circuit, the workpiece carriers can be used automatically again and again to manufacture another battery. The transport path transports or conveys the workpiece carriers to various positions at which a machine tool can carry out a step of the method for manufacturing a battery. In some cases, the steps can also be carried out during the movement between positions.

Further features and variants of the invention are apparent from the accompanying figures, which show forms of the invention in a solely schematic manner. In detail:

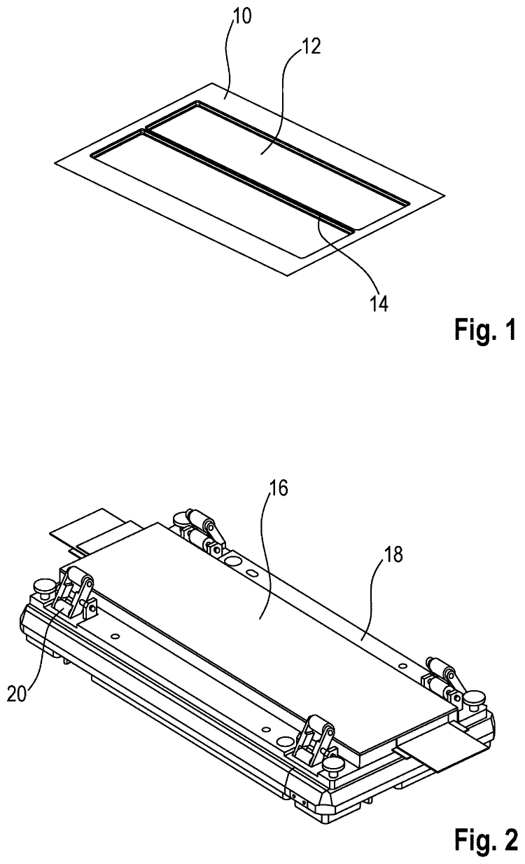

FIG. 1 is an isometric view of a pouch blank;

FIG. 2 is an isometric view of an electrode stack fixed in a stack holder;

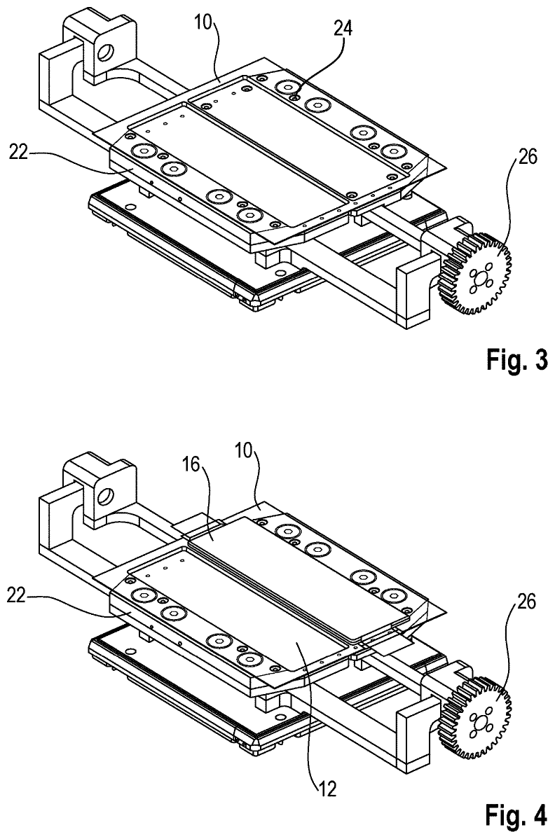

FIG. 3 is an isometric view of a workpiece carrier with a pouch blank fixed thereon;

FIG. 4 is an isometric view as in FIG. 3, wherein an electrode stack is inserted into a depression in the pouch blank;

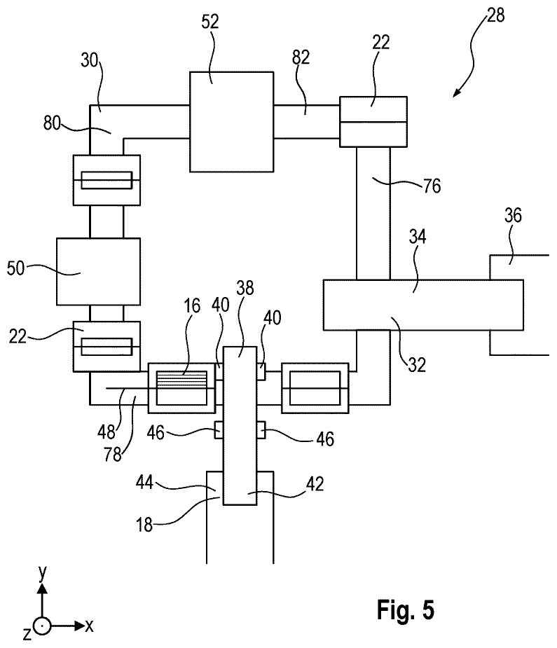

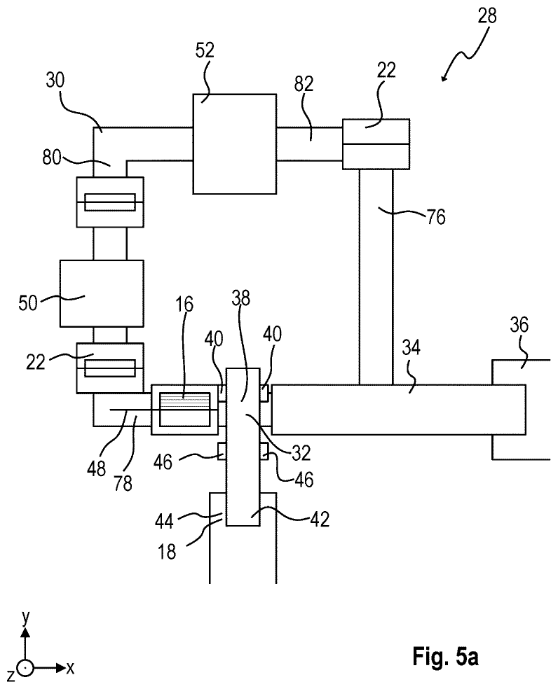

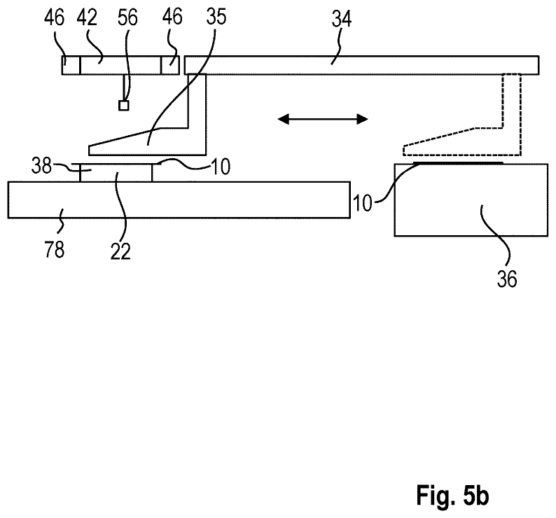

FIG. 5 is a schematic view of an apparatus for manufacturing a battery according to an embodiment of the present invention;

FIG. 5a is a schematic view of an apparatus for manufacturing a battery according to another embodiment of the present invention;

FIG. 5b is a schematic side view of a transport device for the apparatus according to FIG. 5b with an adapted arm;

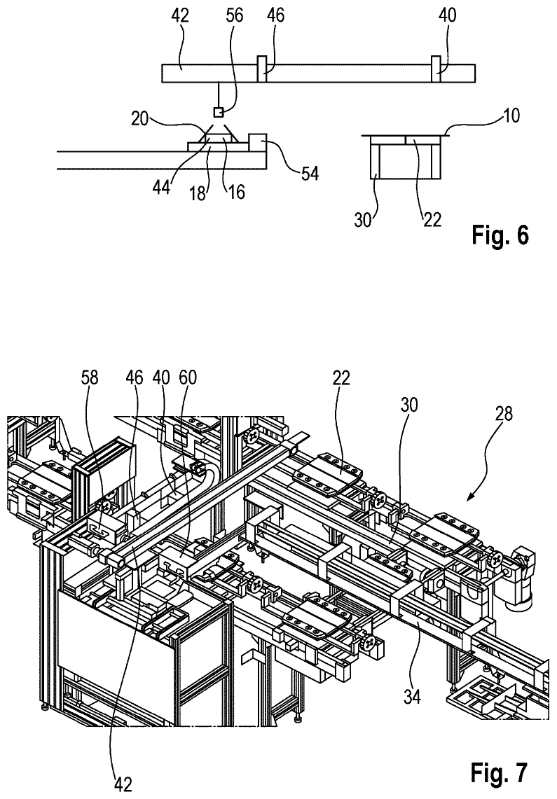

FIG. 6 is a schematic side view of a gripping device for transporting the electrode stack;

FIG. 7 is an isometric view of a partial region of an apparatus for manufacturing a battery;

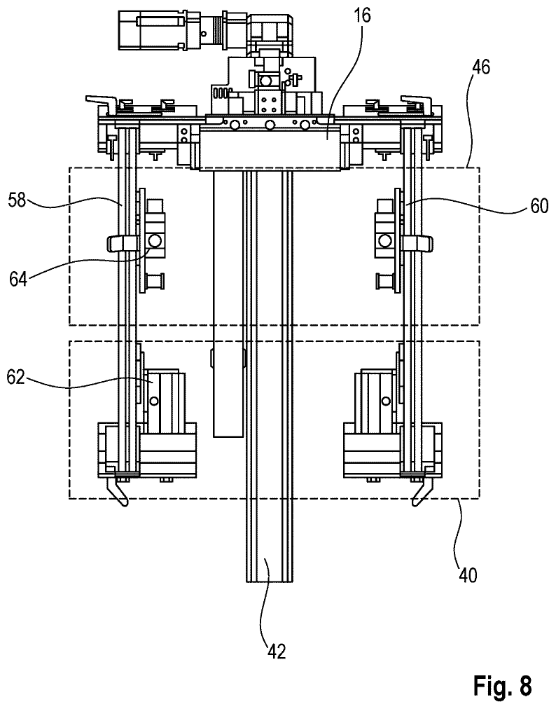

FIG. 8 is a schematic view from below of the gripping device with two holding apparatuses with optical detection devices;

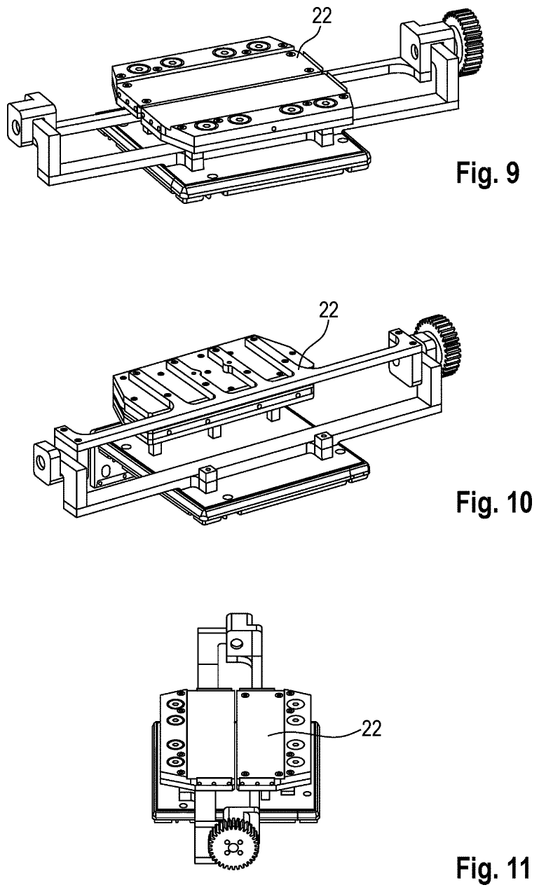

FIG. 9 is an isometric view of the workpiece carrier in the open state;

FIG. 10 is an isometric view of the workpiece carrier in the closed state in which the pouch blank is folded;

FIG. 11 is an isometric view of the workpiece carrier;

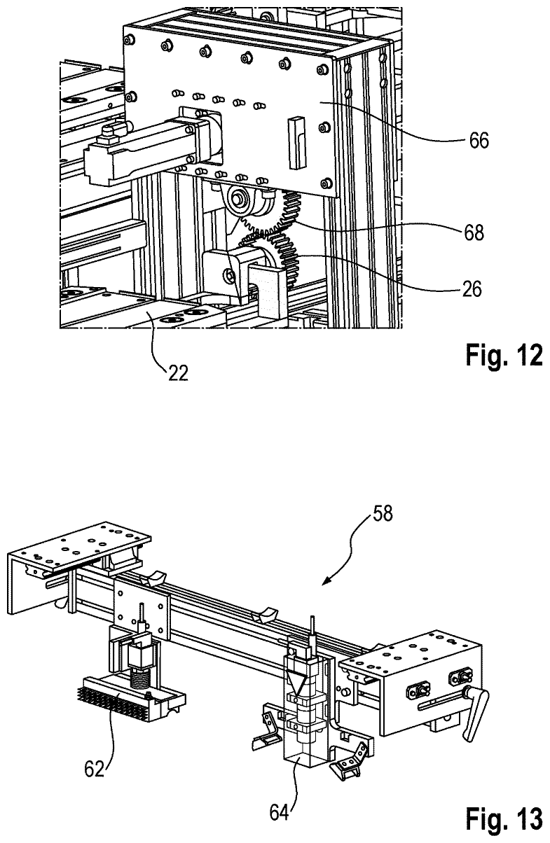

FIG. 12 is a schematic view of an actuation device;

FIG. 13 is a schematic 3D view of a holding apparatus;

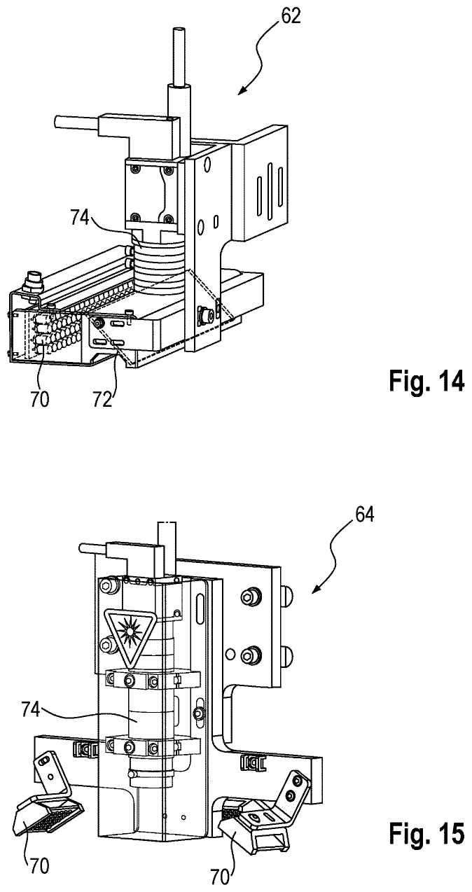

FIG. 14 is a schematic 3D view of a first optical detection device and

FIG. 15 is a schematic 3D view of a second optical detection device.

A pouch blank 10 shown in FIG. 1, which has two depressions 12 that abut each other along a fold line 14, is used for manufacturing a battery.

An electrode stack 16, shown in FIG. 2, is inserted into the pouch blank 10 to manufacture the battery. The electrode stack 16 is prepared for this purpose and fixed on a stack holder 18 by a fixing device 20 arranged on the stack holder 18.

The fixing device 20 can have clamping devices 21, which are for example assigned to each other in pairs. In the present exemplary embodiment, two pairs of clamping devices 21, i.e. a total of four clamping devices 21, are shown. A different number, for example two, six, eight or more, is possible. The clamping devices 21 are movable, for example pivotably mounted, between a clamping position shown in FIG. 2 and an open position. The electrode stack 16 is removable when the clamping devices 21 are in the open position and is fixed when the clamping devices 21 are in the clamping position.

Similarly, as shown in FIG. 3, the pouch blank 10 is arranged on a workpiece carrier 22. The pouch blank 10 can be fixed for example by a suction device 24, which can suck the pouch blank 10 firmly onto the workpiece carrier 22 by means of a vacuum.

The workpiece carrier 22 has a folding device and can be constructed in several parts, for example in two parts, to form said device, wherein at least one of the parts, for example a support surface for the pouch blank 10, is arranged to be rotatable or pivotable, so that the pouch blank 10 can be folded in the workpiece carrier 22 along the folding line 14. For example, the folding device is transferred from an open state to a closed state. To carry out the folding process, an adjusting element, in particular an adjusting wheel 26, is provided on the workpiece carrier 22, by means of which a folding actuator can effect the folding process from the outside.

One or more of the parts of the workpiece carrier 22 can have a holding device, for example one or more magnets, for example to hold the workpiece carrier 22 in a folded state.

The workpiece carrier 22 has a receiving region for receiving one or more depressions 12 in the pouch blank 10. The receiving region can further comprise one or more connecting sections for dividing the receiving region and/or for positioning the pouch blank 10. The holding device can be arranged in a region which is adjacent to the receiving region and projects above the receiving region in a height direction.

Before the pouch blank 10 is folded, the electrode stack 16 is removed from the stack holder 18 in one step and, as shown in FIG. 4, inserted into one of the depressions 12.

The positioning of the electrode stack 16 in the depression 12 has a decisive influence on the quality of the battery manufactured.

For efficient and precise execution of these and further steps of the method for manufacturing a battery, for example an apparatus 28 for manufacturing a battery can be used as shown in FIG. 5.

The apparatus 28 shown in FIG. 5 for manufacturing a battery has a transport section 30 for transporting workpiece carriers 22. The workpiece carriers 22 can be moved between multiple positions by means of the transport path 30.

The transport path 30 has a first transport segment 76, a second transport segment 78, a third transport segment 80 and a fourth transport segment 82, each of which has a conveyor device for moving the workpiece carriers 22 along a straight line. The first transport segment 76 and the third transport segment 80, as well as the second transport segment 78 and the fourth transport segment 82, are each spaced apart from one another and arranged parallel to one another, so that in the present embodiment a rectangular floor plan of the transport path 30 results. As a result, workpiece carriers 22 are transported on the first and third transport segments 76, 80 parallel to each other, but in opposite directions. The same applies to the second and fourth transport segments 78, 82.

Ends of the transport segments 76, 78, 80, 82 are connected to one another in such a way that a workpiece carrier 22 at one end of a transport segment 76, 78, 80, 82 is transferred to another transport segment 76, 78, 80, 82. As a result, the workpiece carriers 22 can be conveyed by the transport segments 76, 78, 80, 82 in such a way that they can be transferred back to the first transport segment 76 when they leave the fourth and thus last transport segment 82. In the present case, a workpiece carrier 22, after the pouch manufactured with it has been removed from it, is thus moved empty back to the beginning of the manufacturing process so that another battery can be manufactured therewith. The transport segments 76, 78, 80, 82 thus form a circuit for the workpiece carriers 22.

Each transport segment 76, 78, 80, 82 can have one or more positions at which one or more steps of a method for manufacturing a battery are carried out. For this purpose, the workpiece carrier 22 can be stopped at these positions or one or more steps can be carried out during the movement of the workpiece carrier 22.

In further embodiments, the apparatus 28 can for example have more or fewer than four transport segments 76, 78, 80, 82. In further embodiments, the transport segments 76, 78, 80, 82 can allow transport along any curve instead of a straight line, for example along an elliptical or circular segment. In further embodiments, one or more of the transport segments 76, 78, 80, 82 and the conveying path of the transport device 34 are arranged collinearly.

The empty workpiece carrier 22 is first moved to a first position 32 of the first transport segment 76. At position 32, in one process step, a pouch blank 10 is taken from a supply device 36 by a transport device 34 and placed on the workpiece carrier 22.

In a further method step, the suction device 24 of the workpiece carrier 22 generates a negative pressure so that the pouch blank 10 is fixed on the workpiece carrier 22.

The workpiece carrier 22 is then moved into a second position 38 of the second transport segment 78. While the workpiece carrier 22 is being moved into the second position 38, or when it has arrived in the second position 38, a position, i.e. a position and/or a rotation, of the pouch blank 10 is detected by a first optical position detection device 40. The first optical position detection device 40 performs this detection with reference to a reference system relative to which the position and/or rotation is detected.

For this purpose, the first optical position detection device 40 captures, for example using one or more cameras, images of the pouch blank 10 in the visible and/or invisible region in which structures of the pouch blank 10, for example one, two or more corners of the depression 12 and/or one or more edges of the depression 12, are visible.

A position of the structures within the image recording is first ascertained for example by a control device in which, for example, image processing software is executed. Algorithms for finding corners and edges are known, e.g. the Hough transform, template matching, or structure tensors. In addition, artificial intelligence methods, in particular CNNs, can be used.

From the optical properties of the cameras used and the known arrangement of the camera on the apparatus 28, a position of the pouch blank 10 relative to a reference system can then be ascertained from the positions of the structures.

In the present embodiment, the position of at least two corners of the depression 12 is ascertained, wherein the corners are arranged, for example, opposite one another or diagonally on the depression 12.

In a further method step, a gripping device 42, for example a pick-and-placer, picks up a prepared electrode stack 16 at a pick-up position 44 from the stack holder 18 and transports it to the workpiece carrier 22, which is waiting at the second position 38. One of the depressions 12 in the pouch blank 10, which is fixed on the workpiece carrier 22, defines an insertion position for the electrode stack 16.

The insertion position is the position into which the electrode stack 16 has to be brought in order to be correctly arranged within the depression 12 in the pouch blank 10. A correct arrangement can be defined by various criteria, for example by aligning side walls of the electrode stack 16 parallel to side walls of the depression 12, or by arranging corners of the electrode stack 16 adjacent to corners of the depression 12. In particular, a correct arrangement ensures that the pouch blank 10 is foldable so that the two depressions 12 enclose the electrode stack 16 and that the pouch blank 10 can be sealed in the folded state to form a battery. Furthermore, when correctly arranged, for example, terminals of the electrode stack 16 are arranged such that they can be reached from the outside at predetermined positions of the battery when the pouch blank 10 is in the folded state.

While the electrode stack 16 is being transported from the pick-up position 44 to the insertion position, a position of the electrode stack 16 on the gripping device 42 is detected by a second optical position detection device 46. The position can also be detected relative to the reference system in a manner analogous to the detection of the position of the pouch blank 10 described above.

Before the electrode stack 16 is inserted into the insertion position, an alignment correction for the gripping device 42 is calculated by a control device from the detected position of the pouch blank 10 and the detected position of the electrode stack 16.

The gripping device 42 transports the electrode stack 16 in a y-direction by means of a carrier. In addition, the carrier is movable in a z-direction so that the electrode stack 16 can be raised and lowered. To apply the alignment correction, the carrier is further rotatable at least about the z-direction, so that a rotation of the electrode stack 16 can be corrected.

The gripping device 42 thus adjusts the position of the electrode stack 16, i.e. its position and/or rotation, during transport into the insertion position in such a way that the electrode stack 16 is correctly arranged in the depression 12, as described above.

In further embodiments, the carrier is additionally movable in the x-direction, so that an alignment correction in the x-direction can be easily implemented.

To detect the position, the optical position detection devices 40, 46 can for example have a corner detection device that is configured to detect at least two corners and/or a side edge of the depression 12 or the electrode stack 16. The correction instructions are then calculated based on a specified ideal arrangement of the corners and/or side edges relative to each other.

In some embodiments, the second optical position detection device 46 captures an image of the electrode stack in a visible and/or non-visible region of light. Depending on the embodiment, for example, from each corner of the electrode stack 16 an image can be captured that contains a picture of a corner of the electrode stack 16. In a further step, a position and/or rotation of the corner relative to the reference system is then ascertained from the image data, as described above.

In some embodiments, for example two corners can be captured with each capture of an image, so that only two image captures are necessary.

The position detection devices 40, 46 can capture any images of the corners of the electrode stack 16 and/or the pouch blank 10 in order to detect their position. For example, if the size and/or shape of the electrode stack 16 and/or of the pouch blank 10 is clearly known, it can be sufficient to detect two corners, for example two corners connected by an edge, two diagonally opposite corners, or three corners.

In some embodiments, the gripper includes a pressure sensor for controlling an insertion force that the gripping device must apply to insert the electrode stack 16 into the depression 12. In order to prevent the electrode stack 16 or the pouch blank 10 from being damaged during insertion, insertion is interrupted when a predetermined maximum force is exceeded.

In some embodiments, the second optical position detection device 46 is configured to check a quality of the electrode stack 16. If the quality of the electrode stack 16 is insufficient, the electrode stack 16 can be placed in a reject position (not shown) which for example is adjacent to the insertion position 38, instead of in the depression 12.

After insertion of the electrode stack 16 into the depression 12, the workpiece carrier 22 is transported further. In a further position downstream of the insertion position 38 or during the movement of the workpiece carrier 22, the workpiece carrier 22 is folded by a first folding actuator 48 which engages in the adjusting wheel 26 of the workpiece carrier 22, i.e. the folding device is transferred from the open state to the closed state and the pouch blank 10 is thereby folded along the folding line 14.

In a third position, a closing position 50, sections, for example adjacent sections and/or edge sections, of the folded pouch blank 10 are at least partially connected to one another, in particular fused and/or sealed, in a further method step to form a pouch of the battery. For filling the pouch, a region where the sections are not connected can remain as a filling opening. In further embodiments, the third position 50 can be arranged on any transport segment 76, 78, 80, 82.

Next, the workpiece carrier 22 is moved to a fourth position, a removal position 52. In the fourth position or on the way there, the workpiece carrier 22 is folded open by a second folding actuator 48, so that the created pouch with the electrode stack 16 contained therein can be removed by a gripping device (not shown) assigned to the fourth position. The second folding actuator 48 can, for example, be integrated in the transport portion or at the closing position 50 or the removal position 52. After the pouch has been removed, the workpiece carrier 22 can be used again and the process starts again.

In a further embodiment of the apparatus, as shown in FIG. 5a, the first position 32 and the second position 38 are essentially identical, so that the workpiece carrier 22 is not moved after the pouch blank 10 has been deposited; rather, the electrode stack 16 is inserted in the same position 32, 38. In some embodiments, a step can be provided in which the workpiece carrier 22 performs a correction and/or adjustment of its position and/or rotation after the pouch blank 10 has been placed thereon.

Since the workpiece carrier 22 is not moved with the pouch blank 10 on it, the position of the pouch blank 10 on the workpiece carrier 22 cannot change due to headwind during the movement, for example from the first position 32 to the second position 38. Furthermore, in these embodiments, it is not necessary to supply the workpiece carrier 22 with a vacuum on its path from the first position 32 to the second position 38 in order to fix the pouch blank 10 thereon. Rather, it is thereby possible to first place the pouch blank 10 on the workpiece carrier 22, then optionally to fix or hold the pouch blank 10 on the workpiece carrier 22 using the suction device 24, and then to insert the electrode stack 16 as already described. In this way the structure of the apparatus 28 is simplified.

To ensure that the pouch blank 10 can be deposited under the gripping device 42 without parts of the gripping device 42 for the electrode stacks 16 and the transport device 34 for the pouch blanks 10 being able to collide with each other during operation, the transport device 34 is designed as shown in FIG. 5b. For transporting the pouch blanks 10 from the supply device 36 to the insertion position 38, an arm 35 is displaceably arranged on the transport device 34. The arm 35 is asymmetrical or L-shaped so that it can engage in a space between the workpiece holder 22 and the gripping device 42.

To transport a pouch blank 10, the arm 35 is moved into a pick-up position above the provision device 36 (shown in dashed lines on the far right in the figure), with a pouch blank 10 being placed ready on the provision device 36. The arm 35 picks up the pouch blank 10, for example by means of a vacuum, and is moved over the insertion position 38, where the pouch blank 10 is placed on the workpiece carrier 22.

In some embodiments, a lifting device by which the workpiece carrier 22 can be lifted is arranged in the second position 38. The lifting device can further comprise, for example, prismatic, spherical, pyramidal and/or differently shaped positioning devices which engage in correspondingly shaped openings or depressions in the workpiece carrier 22 and position it precisely. This means that it is not necessary for the transport segments 76, 78, 80, 82 to make possible a very precise positioning of the workpiece carrier 22. In some embodiments, the workpiece carrier 22 can be separated from the transport segment 76, 78, 80, 82 during lifting in order to position it precisely.

In some embodiments, the positions 32, 38, 50, 52 are disposed on any transport segments 76, 78, 80, 82.

In FIG. 6 the function of the gripping device 42 at the second position 38 is shown in greater detail. The stack holder 18, on which the electrode stack 16 is fastened by the fixing device 20, has been moved into the receiving position 44 and arranged there. By means of an unlocking device 54, the clamping devices 21 of the fixing device 20 are unlocked so that a carrier 56 of the gripping device 42 can receive the electrode stack 16. The carrier 56 has, for example, a suction device for fixing the electrode stack 16 to the carrier 56.

While the carrier 56 with the electrode stack 16 is being transported from the receiving position 44 to the pouch blank 10, it is moved past the second optical position detection device 46 and below it. In other words, the second optical position detection device 46 is assigned to the side of the electrode stack 16 which abuts the carrier 56 of the gripping device 42. The carrier 56 has a shape that allows the second optical position detection device 46 to detect corners and/or edges of the electrode stack 16. For example, the carrier 56, viewed from above, can have a smaller silhouette than the electrode stack 16. Or, in other words, the carrier 56 is small enough for the electrode stack 16 to project beyond it with at least two corners.

A further embodiment of the apparatus 28 is shown in FIG. 7. The first optical position detection device 40 and the second optical position detection device 46 each have two optical detection devices 62, 64. Each of the optical detection devices 62, 64 can for example be individually attached to the apparatus 28.

Alternatively, a first holding apparatus 58 can be provided, to which an optical detection device 62 of the first optical position detection device 40 and an optical detection device 64 of the second optical position detection device 46 are attached. In this way, installation effort, for example when replacing defective components, is reduced, so that downtimes are reduced, for example. In further embodiments, in addition to the first holding apparatus 58, a second holding apparatus 60 can be provided to which two optical detection devices 62, 64 are attached, analogously to the first holding apparatus 58.

In further embodiments, the holding apparatus 58, 60 can for example have optical detection devices 62, 64 of the same position detection device 40, 46 or of different position detection devices 40, 46. In further embodiments, two, three, four or more optical detection devices 62, 64 can be attached to the holding apparatus 58, 60. The optical detection devices 62, 64 can for example comprise cameras, infrared cameras or modules comprising a camera module and an illumination device.

The apparatus 28 can have a lifting device (not further illustrated). The lifting device is used to convey a stack holder 18 from the pick-up position 44 along a vertical direction after the electrode stack 16 has been removed from the stack holder 18.

FIG. 8 shows the arrangement of the first optical position detection device 40 and the second optical position detection device 46 relative to the gripping device 42 as seen from the transport path 30 or from the workpiece carrier 22, i.e. from below. The first optical position detection device 40 has first detection devices 62 and the second optical position detection device 46 has second detection devices 64. The detection devices 62, 64 are arranged, for example, on two sides, in particular on two opposite sides of the gripping device 42. This improves the view of the detection devices 62, 64 onto the workpiece carrier 22.

FIG. 9, FIG. 10 and FIG. 11 show different views of the workpiece carrier 22. The workpiece carrier 22 shown in FIG. 10 was folded by actuating the adjusting wheel 26 so that a pouch blank 10 arranged therein would be folded.

FIG. 12 shows an actuation device 66 for actuating the adjusting wheel 26, which device has a folding actuator 48, for example an actuator wheel 68, which engages with its teeth in the teeth of the adjusting wheel 26 in order to fold or unfold the workpiece carrier 22. Such an actuation device 66 can be arranged either at one of the described positions 32, 38, 50, 52 or at a separate, further position.

Furthermore, in some embodiments, a second actuation device 66 is provided which is configured and arranged to unfold the workpiece carrier 22, in particular after the pouch blank 10 has been sealed at least in some sections.

A further embodiment of a first holding apparatus 58 with a first optical detection device 62 and a second optical detection device 64 is shown in FIG. 13. The first optical detection device 62 and the second optical detection device 64 are movably arranged and releasably fixed to the holding apparatus 58 so that their position can be easily adjusted. Likewise, the holding apparatuses 62 are movably mounted on the gripping device 42 and releasably fixed so that their position can be easily adjusted.

A first optical detection device 62 shown in FIG. 14 has a light source 70, for example a group of LEDs, and a semi-transparent mirror 72, so that light which strikes the pouch blank 10 in an optical axis of a camera 74 can be used to ascertain the position of corners and/or edges of the depression 12 in the pouch blank 10. As a result, vertical reflections from the surface of the pouch blank 10 in particular are better detected.

Light sources 70 of the second optical detection device 64 are shown in FIG. 15. The light sources 70 comprise, for example, a group of LEDs or other suitable light sources. The light sources 70 are arranged for example inclined to an optical axis of a camera 74.

In some embodiments, one or more of the detection devices 62, 64 can operate in the infrared range. In some embodiments, at least one of the light sources 70 of the first and/or of the second optical detection device 62, 64 is configured to emit infrared light with a wavelength between about 780 nm and about 1000 nm. If the electrode stack 16 is surrounded by a separator film, this separator film can be at least partially transparent in the infrared light range. Thus, by using infrared light and infrared cameras, the corners of the electrode stack 16 are visible with greater contrast when they are covered by such a separator film.

In some embodiments, a control device is provided which in particular controls and/or verifies the sequence of the manufacturing method. In addition, such a control device can for example carry out image processing, in particular the recognition of structures, corners and/or edges, and/or can be configured to calculate the alignment correction.

The devices and process steps mentioned here can be implemented in part as software modules, i.e. as machine-readable instructions for execution by a computer. In particular, the controlling of the method as well as image capturing and processing can be implemented in this way. The above-mentioned devices require electrical energy to operate. For the sake of clarity, a corresponding distribution network for electrical power is not shown. It is also understood that the devices can be connected to one another by communication, signal and control lines, without these communication, signal and control lines being shown here.

### LIST OF REFERENCE SIGNS

10 pouch blank
12 depression
14 fold line
16 electrode stack
18 stack holder
20 fixing device
21 clamping device
22 workpiece carrier
24 suction device
26 adjusting wheel (adjusting element)
28 apparatus (for manufacturing a battery)
30 transport path
32 first position
34 transport device
35 arm
36 supply device
38 second position (insertion position)
40 first optical position detection device
42 gripping device
44 receiving position
46 second optical position detection device
48 folding actuator
50 third position (closing position)
52 fourth position (removal position)
54 unlocking device
56 carrier
58 first holding apparatus
60 second holding apparatus
62 first optical detection device
64 second optical detection device
66 actuation device
68 actuator wheel (folding actuator)
70 light source
72 semi-transparent mirror
74 camera
76 first transport segment
78 second transport segment
80 third transport segment
82 fourth transport segment

1. A method for manufacturing a battery having an electrode stack and a pouch for receiving the electrode stack, comprising the steps of:
a) moving a workpiece carrier with a pouch blank arranged thereon into an insertion position;
b) measuring a position of at least two structures of a depression of the pouch blank relative to a reference system;
c) moving a carrier of a gripping device with the electrode stack fixed to the carrier from a receiving position into the insertion position;
d) during step c), measuring a position of at least two structures of the electrode stack relative to the reference system;
e) calculating an alignment correction for the electrode stack(from the positions of the structures such that when the electrode stack is inserted into the depression, the structures of the electrode stack and the depression each lie adjacent to one another, and,
f) rotating and/or shifting, during step c), the carrier with the electrode stack according to the alignment correction.

2. The method for manufacturing a battery according to claim 1 further comprising:
h) before step a), picking up a pouch blank from a transfer position;
i) placing the pouch blank on the workpiece carrier, and,
j) fixing the pouch blank on the workpiece carrier.

3: The method for manufacturing a battery according to claim 1 further comprising:
k) before step c), moving a stack holder on which the electrode stack is fixed into the receiving position;
l) unlocking the fixing of the electrode stack to the stack holder; and,
m) receiving the electrode stack by the carrier.

4. The method according to claim 1, wherein in step b) at least one image of one or more structures of the depression of the pouch blank is created by a first camera and/or a second camera of a first optical position detection device and/or in step d) at least one image of one or more corners of the electrode stack is created by a first camera and/or a second camera of a second optical position detection device, wherein the measuring is carried out by image processing on the basis of the image recordings.

5. An apparatus for manufacturing a battery, comprising an electrode stack and a pouch for receiving the electrode stack, which pouch can be manufactured from a pouch blank having at least one depression created by folding along a fold line, comprising a plurality of movable workpiece carriers, on each of which a pouch blank can be arranged,
a gripping device with a carrier that can be positioned in two spatial directions and is rotatable about one of the spatial directions for transporting the electrode stack from a receiving position to an insertion position in one of the depressions;
a first optical position detection device for detecting a position of the pouch blank arranged on one of the workpiece carriers relative to a reference system;
a second optical position detection device for detecting a position of the electrode stack relative to the reference system; and
a control device for ascertaining an alignment correction for the carrier and/or the workpiece carrier, comprising an item of translation and/or rotation information for positioning the electrode stack in the depression.

6. The apparatus for manufacturing a battery according to claim 5, wherein the second optical position detection device is arranged and configured to detect the position during the transport of the electrode stack from the receiving position to the insertion position.

7. The apparatus for manufacturing a battery according to claim 5, wherein the second optical position detection device is arranged on a side of the electrode stack facing the gripping device.

8. The apparatus for manufacturing a battery according to claim 5, wherein the second optical position detection device is arranged and configured to detect the positions of at least two corners of the electrode stack.

9. The apparatus for manufacturing a battery according to claim 5, wherein the first optical position detection device is arranged and configured to detect the positions of at least two corners of a depression of the pouch blank.

10. The apparatus for manufacturing a battery according to claim 5, wherein for collection, the electrode stack is provided fixed in the receiving position on a stack holder, wherein an unlocking device is provided for releasing the fixing.

11. The apparatus for manufacturing a battery according to claim 5, wherein the workpiece carrier has a folding device for folding the pouch blank along the fold line such that the electrode stack is enclosed by the two depressions, wherein the folding device has an open state and a closed state.

12. The apparatus for manufacturing a battery according to claim 11, wherein a sealing station is provided at which a pouch blank with an electrode stack in a workpiece carrier can be at least partially sealed in the closed state.

13. The apparatus for manufacturing a battery according to claim 5, wherein the carrier of the gripping device has a suction plate with vacuum openings for fixing the electrode stack to the carrier, wherein the carrier and/or the suction plate are designed such that at least corner regions of the electrode stack are visible from the side of the gripping device.

14. The apparatus for manufacturing a battery according to claim 5, wherein a common insertion position for the insertion of the pouch blank into the workpiece carrier and for the insertion of the electrode stack into the depression in the pouch blank.

15. The apparatus for manufacturing a battery according to claim 5, wherein a transport path which has a plurality of transport segments, wherein the transport segments are arranged and configured to transport the workpiece carriers between a plurality of positions, wherein the transport path is arranged and configured to form a circuit for the workpiece carriers, and wherein at least one insertion position is arranged on or at one of the transport segments.
